(19) United States
(12) Patent Application Publication
(10) Pub. No.: US 2013/0093187 A1
(43) Pub. Date: Apr. 18, 2013

(54) METHOD FOR GENERATING ADDITIONAL ELECTRIC ENERGY IN ELECTRIC BICYCLES

(71) Applicant: JAE HYUN LIM, CRESSKILL, NJ (US)

(72) Inventor: JAE HYUN LIM, CRESSKILL, NJ (US)

(21) Appl. No.: 13/442,052

(22) Filed: Apr. 9, 2012

(51) Int. Cl. H02K 13/00

(52) U.S. Cl. CPC H02K 13/00
USPC 290/50

(57) ABSTRACT

Disclosed is a method to create an extra electric energy source to power electric batteries while the electric bicycle is in motion. This electric energy source is generated from a separate installed component (a specially designed generator). This component converts the rotational energy from a shaft connected to the wheel through a delivery device.

### BACKGROUND OF THE INVENTION

With the rising costs of fossil fuels, there has been a hiking demand for renewable energy and many technological improvements have been developed to address this issue. With these renewable energy technology developments, many people have switched from conventional vehicles powered by fossil fuels to vehicles that run with renewable energy, such as electric bicycles, to reduce transportation costs. The main advantages of an electric bicycle are that it is inexpensive, requires relatively simple maintenance, and assists the operator with power from the motor.

### BRIEF SUMMARY OF THE INVENTION

This method presents an additional renewable energy source for recharging batteries installed in electric bicycles in motion. This is done by withdrawing rotational energy from an attached rotating shaft connected to the wheel to a specially designed generator installed onto a bicycle component.

The key concept of this method is that the mechanical rotational energy from the shaft connected to the wheel is converted to electric energy while the bicycle is in motion, which recharges the batteries. This is a way to continuously supply a recharging source of electricity, which would increase the battery usage ratio per full battery charge. This would offer significant performance benefits in mileage per complete battery charge and make electric bicycles more reliable.

### BRIEF DESCRIPTION OF DRAWINGS

This method can be clearly explained with reference to the following drawings:

FIG. 1 is an illustration of the delivery device connecting the rotating shaft (attached to the wheel) to the main shaft of the installed specially designed generator.

FIG. 2 is an illustration of an instance of the arrangement of installed components in accordance to the present method.

FIG. 3 is a cross sectional view of the specially designed generator.

FIG. 4 is an illustration of an electric bicycle's recharging system in accordance to the present method.

### DETAILED DESCRIPTION OF THE INVENTION

The electric bicycle's batteries supply power to assist the operator with power to rotate the pedals which all work to move the bicycle by rotating the wheels.

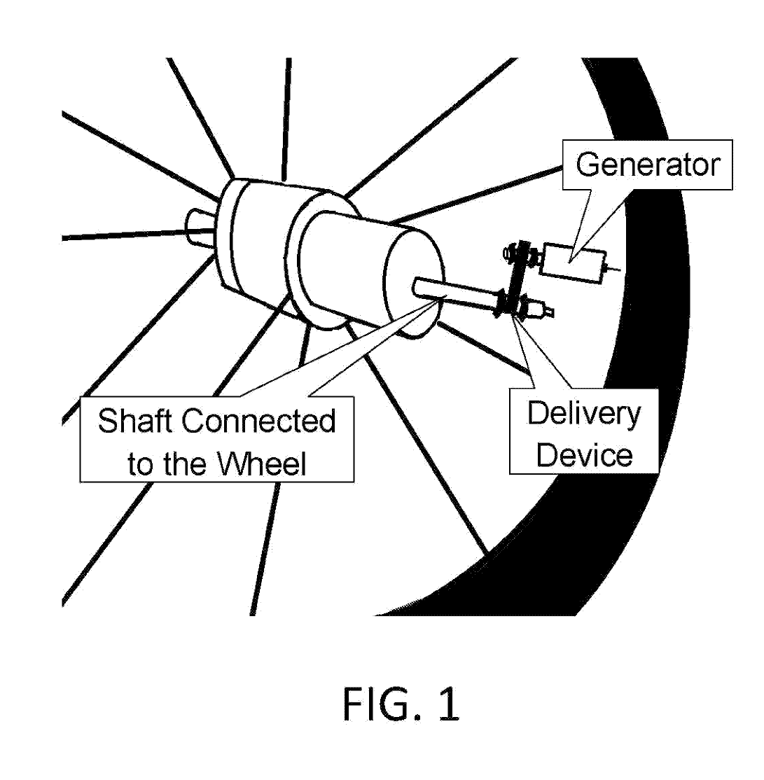

The delivery device in FIG. 1 transfers the rotational energy from the shaft (connected to the wheel) to the specially designed generator's main shaft. This delivery device can be composed of a belt, chain, gears, or any other suitable material.

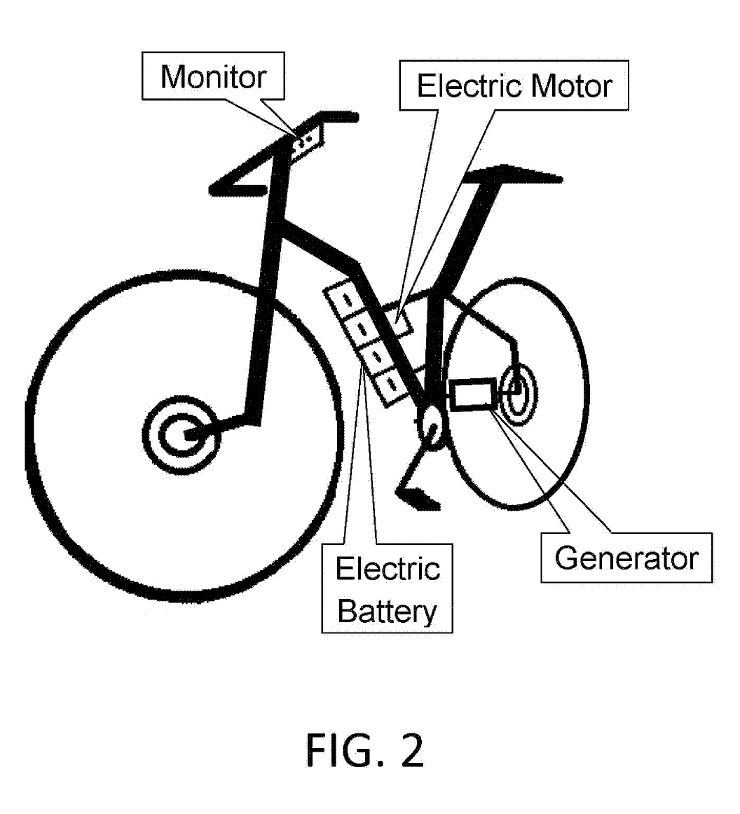

All the components used in this method are shown in FIG. 2.

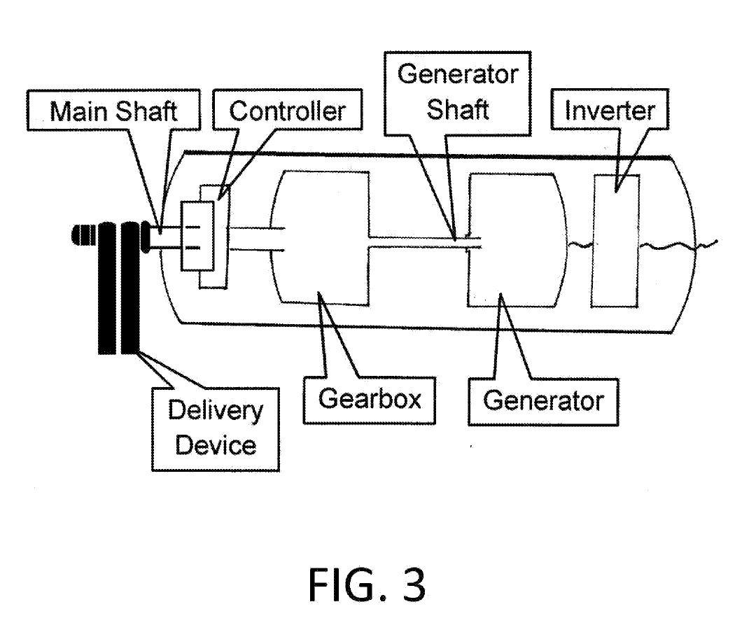

The specially designed generator shown in FIG. 3 consists of a controller, a gearbox, a generator, and an inverter. The controller consists of a brake system and a sensor. The brake system manages the rotational speed of the main shaft, which depends on the operator's cycling patterns. The sensor regulates the temperature of the generator by adjusting the brake system to control the rotational speed of the main shaft. The gearbox transfers the rotational velocity of the main shaft to the generator shaft which would result in a controlled rotational velocity. The generator converts the mechanical rotational energy of the generator shaft to electrical energy. Then, the electrical energy, through the inverter, recharges the electric batteries.

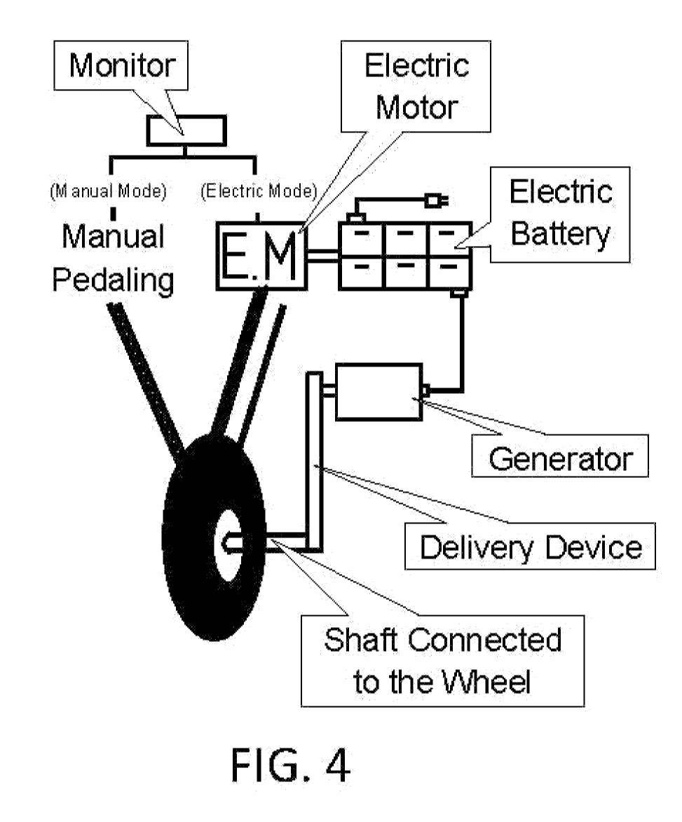

FIG. 4 illustrates the recharging system of this method: the rotating shaft connected to the wheel delivers the rotational energy to the main shaft of the generator through the delivery device, in which the resulting electric energy from the generator recharges the batteries, in which then supplies electric power to the motor. The monitor controls the two modes: manual pedaling and assisted pedaling by electric power. When the electric bicycle is on manual pedaling mode, the shaft (connected to the wheel) is detached from the wheel which stops the generator operation.

What is claimed is:

1. A method to generate an extra electric energy source to recharge the batteries of electric bicycles in motion by withdrawing the rotational energy from the shaft connected to the wheel to power a separate generator through a delivery device.
